(19) United States
(12) Patent Application Publication
(10) Pub. No.: US 2025/0257877 A1
(43) Pub. Date: Aug. 14, 2025

(54) Household gas stove

(71) Applicant: BSH Hausgeräte GmbH, Munich (DE)

(72) Inventors: Mario Velo Bezanilla, Santander (ES); Emilio Placer Maruri, Liencres (ES); Alvaro Martinez Diez, Peñacastillo (Santander) (ES); Roberto Saiz Gonzalez, Villapresente – Cantabria (ES)

(21) Appl. No.: 18/859,187

(22) PCT Filed: Apr. 12, 2023
(86) PCT No.: PCT/EP2023/059598

§ 371 Date: Oct. 23, 2024

(30) Foreign Application Priority Data
Apr. 28, 2022 (EP) 22382408.7

(51) Int. Cl. F24C 7/08; G05G 1/08; G05G 1/12; H01H 51/28

(52) U.S. Cl. CPC F24C 7/083; G05G 1/082; G05G 1/12; H01H 51/28

(57) ABSTRACT

A household gas stove, comprising a gas burner, a gas valve for controlling a flow of combustion gas to the gas burner, an ignitor for igniting the combustion gas at the gas burner , and a knob mechanism for actuating the gas valve, wherein the knob mechanism comprises a movable magnet for generating a magnetic field and an immovable switch, wherein the switch is switchable from an off mode, in which the switch is outside a range of the magnetic field, into an on mode, in which the switch is within the range of the magnetic field, by means of moving the magnet relative to the switch, wherein the switch activates the ignitor when being switched from the off mode into the on mode.

The present invention relates to a household gas stove.

Household gas stoves usually comprise a burner, a knob to control a gas (in the following, also “combustion gas”) supply to the burner and an ignitor to ignite the gas at the burner. It is desirable to ignite the gas when the gas is supplied to the burner. This can be achieved by complex switching or additional buttons pressed by a user. It is one aspect to reduce the complexity of the knob and to increase the operational safety of the household gas stove by preventing of emitting unburned gas. The complexity of the knob should be reduced, and the operational safety of the household gas stove should be increased by preventing of emitting unburned gas.

It is one object of the present invention to provide an improved household gas stove.

Accordingly, a household gas stove, comprising a gas burner, a gas valve for controlling a flow of combustion gas to the gas burner, an ignitor for igniting the combustion gas at the gas burner, and a knob mechanism for actuating the gas valve is provided. The knob mechanism comprises a movable magnet for generating a magnetic field and an immovable switch, wherein the switch is switchable from an off mode, in which the switch is outside a range of the magnetic field, into an on mode, in which the switch is within the range of the magnetic field, by means of moving the magnet relative to the switch, wherein the switch activates the ignitor when being switched from the off mode into the on mode.

When the gas valve is activated by a movement of a knob element of the knob mechanism, the switch automatically activates the ignitor to ignite the combustion gas at the burner. Thus, no unburned gas will leak into the environment which increases the safety of the household gas stove. Since the ignitor is activated automatically without pressing any additional buttons, it also increases the usability of the household gas stove.

The ignitor can be a spark plug. “Activation” of the ignitor in this context means that the ignitor ignites the combustion gas at the burner. “Activation” can also mean that the ignitor is unblocked so that the ignitor can be switched on by a user. In the on mode of the switch, the switch is closed. In the off mode of the switch, the switch is opened. The on mode of the switch is defined that other devices, in particular the ignitor, are turned on. The off mode of the switch is defined that the other devices are turned off. The movement of the magnet relative to the switch may be a rotational movement or a translational movement, e.g., in a slide control to actuate the gas valve.

According to an embodiment, the switch closes an ignitor circuit of the household gas stove to supply power from a power supply to the ignitor to ignite the combustion gas at the burner when the switch is switched into the on mode.

The household stove comprises an ignitor circuit. The ignitor circuit is connected to the power supply, which may be connected to a household power supply, for example. When the switch is switched into the on mode, the ignitor may ignite the combustion gas at the burner.

According to a further embodiment, the knob mechanism comprises a control element and a knob element which is removable and attachable, wherein the knob element is held to the control element by means of the magnet.

The knob mechanism may be arranged at a top sheet, comprising cooking area, or a panel of the household gas stove. When the knob element is removed, the top sheet or the panel may be a smooth surface which may simplify cleaning the panel or the top sheet. The magnet used for switching the switch may be advantageously used for holding the knob element to the control element. An additional magnet may be saved. Removable” in context with the knob mechanism means that the knob element can be lifted from the control element. The knob element is not fixedly attached to the control element.

According to a further embodiment, the knob mechanism comprises a stem which is arranged between the control element and the knob element, wherein the knob element is attached to the stem.

Preferably, the stem is a cylindrical part which allows a rotational movement of the stem and the knob element and can be inserted into the control element.

According to a further embodiment, the stem and the knob element comprise a rotation axis, wherein the stem and the knob element rotate around the rotation axis relative to the control element, wherein the switch is arranged at the control element, wherein the magnet is arranged at the stem to move the magnet by means of the rotation of the stem around the rotation axis, and wherein the switch switches into the on mode when the movable magnet approaches the switch within the range of the magnetic field generated by the moveable magnet.

According to a further embodiment, the household gas stove further comprises a top sheet, comprising a cooking area, with an upper and a lower surface, wherein the magnet is arranged at the stem above the upper surface of the top sheet, and wherein the switch is arranged at the control element under the lower surface of the top sheet.

When the magnet is arranged at the stem, the magnetic field generated by the magnet is sufficiently strong to use the magnet to attach the knob element to the stem. The upper surface of the top sheet is defined as a surface which faces an environment of the gas stove. The lower surface of the top sheet is defined as a surface which faces away from the environment of the gas stove. The top sheet may be plate shaped. The top sheet can be a glass or glass ceramic plate. The top sheet can also be a steel sheet.

According to a further embodiment, the household gas stove further comprises a device which is turned on when the switch is switched into the on mode and turned off when the switch is switched into the off mode.

By using the switch to turn on other devices, simultaneously to the ignitor, additional switches may be saved. The other devices may be an outer burner surrounding the burner to provide additional heat power, or a vent which is integrated into the household gas stove to remove airborne grease, combustion products, fumes, smoke, heat, and steam from the air.

According to a further embodiment, the device is an illumination device.

The illumination device may show the user of the gas stove that the gas valve is open and combustion gas is supplied to the burner. The illumination device may also show the user that the ignitor is activated.

According to a further embodiment, the switch is a reed switch.

The switch may be also any other magnetic switchable switch.

According to a further embodiment, the magnet is a permanent magnet or a solenoid.

There can also be provided an array of magnets.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

Further embodiments, features and advantages of the present invention will become apparent from the subsequent description and dependent claims, taken in conjunction with the accompanying drawings, in which:

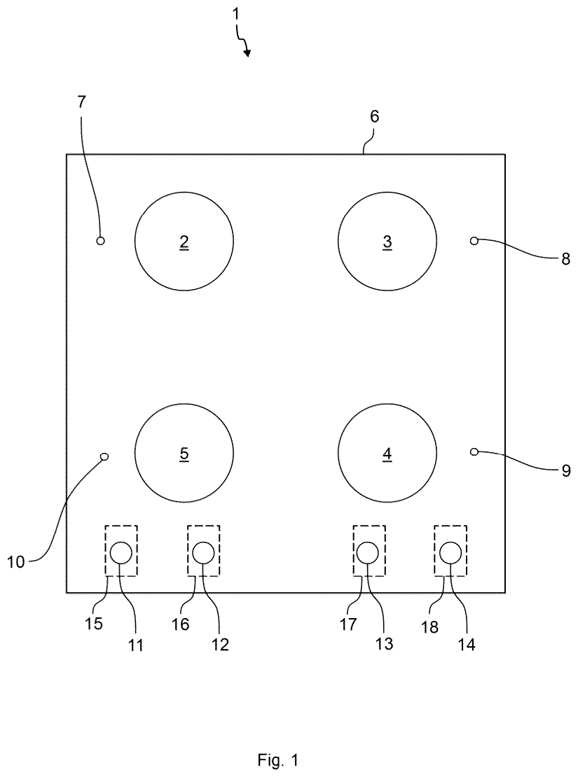

FIG. 1 shows a schematic top view of a household gas stove;

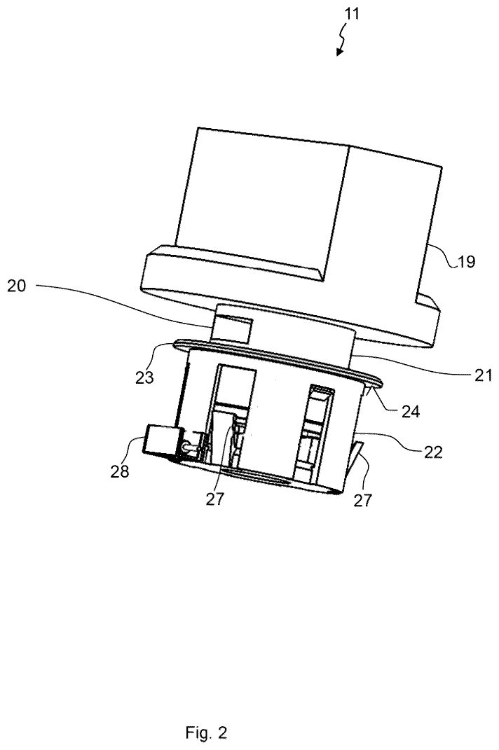

FIG. 2 shows a perspective view of a knob mechanism for the household gas stove;

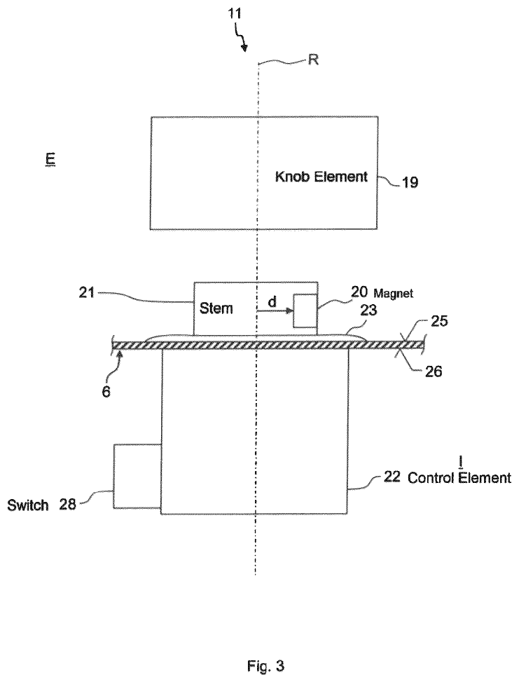

FIG. 3 shows a schematic cross-sectional view of the knob mechanism according to FIG. 2;

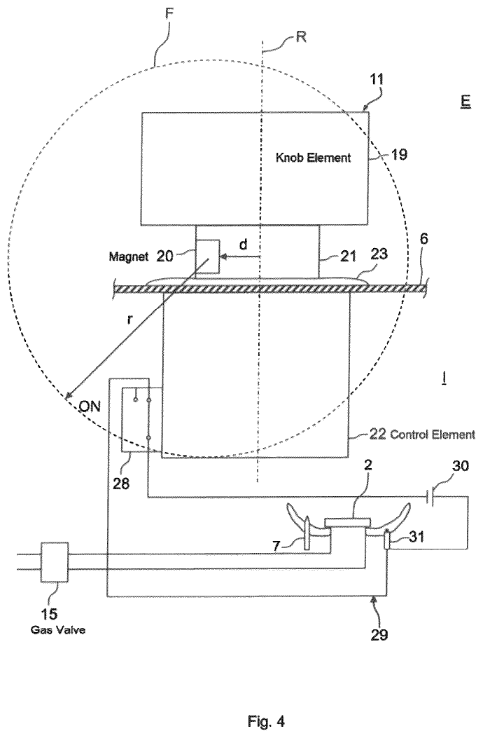

FIG. 4 shows a further schematic cross-sectional view of the knob mechanism according to FIG. 2 when a switch is in an on mode; and

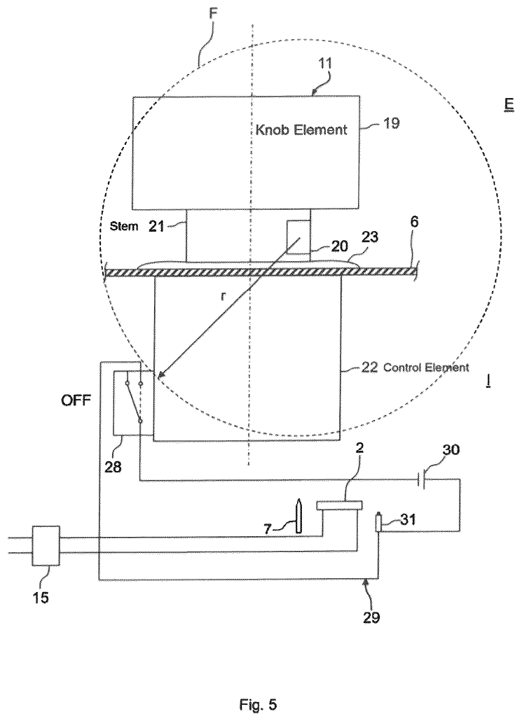

FIG. 5 shows a further schematic cross-sectional view of the knob mechanism according to FIG. 2 when the switch is in an off mode.

In the Figures, like reference numerals designate like or functionally equivalent elements, unless otherwise indicated.

FIG. 1 shows a schematic top view of an embodiment of a household gas stove 1. The gas stove 1 comprises a plurality of gas burners 2 to 5. The number of gas burners 2 to 5 is arbitrary. As FIG. 1 shows, there can be provided four gas burners 2 to 5. The gas burners 2 to 5 protrude over a top sheet 6 of the gas stove 1. The top sheet 6 can be a glass or glass ceramic plate. However, the top sheet 6 can also be a steel sheet. Each gas burner 2 to 5 has a thermocouple 7 to 10 for flame monitoring. The thermocouples 7 to 10 protrude over the top sheet 6. In use of the gas burners 2 to 5, the thermocouples 7 to 10 are heated.

The gas stove 1 has a plurality of knob mechanisms 11 to 14. Each knob mechanism 11 to 14 belongs to a gas valve 15 to 18. The gas valves 15 to 18 are arranged below the top sheet 6. The number of knob mechanisms 11 to 14 is the same as the number of gas burners 2 to 5. Each knob mechanism 11 to 14 is assigned to one gas burner 2 to 5. By means of the knob mechanisms 11 to 14 and the gas valves 15 to 18, a stream of combustion gas from a main gas pipe (not shown) to the assigned gas burner 2 to 5 can be controlled continuously or stepwise.

FIG. 2 shows one of the knob mechanisms 11 to 14 for the household gas stove 1. The functionality of the knob mechanisms 11 to 14 is explained in the following. However, in the following only the knob mechanism 11 will be referred to. The knob mechanism 11 comprises a knob element 19, e.g., a handle. The knob clement 19 is attached by means of a magnet 20 to a stem 21 or any other cylindrical element. The attachment is not fixed so that the knob element 19 can be removed and attached any number of times to the stem 21. The knob element 19 is attached to the stem 21 so that a rotational movement of the knob element 19 is transferred to the stem 21. The knob mechanism 11 further comprises a control element 22, e.g., comprising a housing, into which the stem 21 is partially inserted. The stem 21 may also be entirely accommodated to enable a smooth surface when the knob element 19 is removed.

FIG. 2 illustrates that the control element 22 comprises an entirely surrounding flange 23 with a lower surface 24 pointing towards the household gas stove 1. The top sheet 6 comprises an upper surface 25 (FIG. 3) facing away to an environment E of the household gas stove 1. The top sheet 6 further comprises a lower surface 26 pointing towards an interior I. For example, when the knob mechanism 11 is mounted on the top sheet 6, the lower surface 24 of the flange 23 lies on the upper surface 25 of the top sheet 6 as shown in FIG. 3. The control element 22 comprise a plurality of flexible portions 27 protruding radially outwards of the control element 22. The portions 27 fix the knob mechanism 11 on the lower surface 26 to the top sheet 6 so that the knob element 19 can be removed from the magnet 20 and the control element 22.

FIG. 2 further shows a switch 28 immovable arranged at the control element 22. Preferably, the switch 28 is a reed switch or any other magnetic switchable switch. The switch 28 is switchable into an off mode OFF and into an on mode ON which will be explained later in more detail.

FIG. 3 shows a schematic cross-sectional view of the knob mechanism 11 in a status when the knob element 19 is removed from the stem 21. The stem 21 can also be accommodated in the control element 22, thus a smooth surface with the top sheet 6 can be formed. The magnet 20 is preferably arranged at the stem 21 above the top sheet 6. The magnet 20 may also be arranged below the top sheet 6, for example, when the stem 21 is accommodated in the control element 22. The magnet 20 may also comprise an array of magnets. The magnet 20 can be a permanent magnet or a solenoid. The knob mechanism 11 comprises a rotation axis R. The knob element 19 and the stem 21 rotate around the rotation axis R. The magnet 20 is arranged at the stem 21 with a distance d to the rotation axis R. When the knob element 19 and the stem 21 rotate around the rotation axis R, the magnet 20 moves on a circular path around the rotation axis R.

In the following, the on and off mode of the switch 28 will be described and it is referred to the gas burner 2 and the associated gas valve 15.

FIG. 4 shows a further schematic cross-sectional view of the knob mechanism 11 when the switch 28 is in the on mode ON. The magnet 20 emits a magnetic field F with a range r. When the stem 21 rotates around the rotation axis R, the magnet 20 moves closer to the switch 28 so that the switch 28 is within the range r of the magnetic field F and the switch 28 switches into the on mode ON. The household gas stove 1 comprises an ignitor circuit 29 with a power supply 30 which may be connected electrically to a power supply network of a building (not shown). The power supply 30 may also be a battery.

The household gas stove 1 further comprises an ignitor 31 to ignite the combustion gas which flows from the gas valve 15 to the associated gas burner 2. The number of switches, ignitors and circuits is equal to the number of gas burners 2 to 5. Every switch, ignitor and circuit are associated to one gas burner 2 to 5. The ignitor 31 is included into the circuit 29. When the switch 28 is within the range r of the magnetic field F, the magnetic field F causes the switch 28 to switch into the on mode ON and the switch 28 closes the circuit 29. When the circuit 29 is closed, the ignitor 31 is connected to the power supply 30 and the ignitor 31 ignites the combustion gas at the gas burner 2.

FIG. 5 shows a further schematic cross-sectional view of the knob mechanism according to FIG. 4 when the switch is in an off mode OFF. When the stem 21 rotates around the rotation axis R, the magnet 20 moves away from the switch 28 so that the switch 28 is out of the range r of the magnetic field F. The absence of the magnetic field F causes the switch 28 to switch into the off mode OFF and the switch 28 opens the circuit 29. When the circuit 29 is open, the ignitor 31 is not connected to the power supply 30 anymore and the ignitor 31 can not ignite the combustion gas at the gas burner 2.

In another embodiment, the household gas stove 1 further comprises a device (not shown) which may be turned on when the switch 28 is switched into the on mode ON or turned off when the switch 28 is switched into the off mode OFF. The device may be an illumination device (not shown), an outer burner (not shown) surrounding the gas burner 2 to 5 to provide additional heat power, or a vent (not shown) which is integrated in the household gas stove 1.

Although the present invention has been described in accordance with preferred embodiments, it is obvious for the person skilled in the art that modifications are possible in all embodiments.

### REFERENCE NUMERALS

1 gas stove
2 gas burner
3 gas burner
4 gas burner
5 gas burner
6 top sheet
7 thermocouple
8 thermocouple
9 thermocouple
10 thermocouple
11 knob mechanism
12 knob mechanism
13 knob mechanism
14 knob mechanism
15 gas valve
16 gas valve
17 gas valve
18 gas valve
19 knob element
20 magnet
21 stem
22 control element
23 flange
24 surface
25 surface
26 surface
27 portion
28 switch
29 circuit
30 power supply
31 ignitor
d distance
E environment
F magnetic field
I interior
OFF off mode
ON on mode
r range
R rotation axis

1-10. (canceled)

11. A household gas stove, comprising:
a gas burner,
a gas valve designed to control a flow of combustion gas to the gas burner;
an ignitor designed to ignite the combustion gas at the gas burner; and
a knob mechanism designed to actuate the gas valve and comprising a movable magnet, which is designed to generate a magnetic field, and an immovable switch switchable from an off mode, in which the switch is outside a range of the magnetic field, into an on mode, in which the switch is within the range of the magnetic field, by moving the magnet relative to the switch, wherein the switch activates the ignitor when being switched from the off mode into the on mode.

12. The household gas stove of claim 11, further comprising an ignitor circuit, said switch being designed to close the ignitor circuit to supply power from a power supply to the ignitor to ignite the combustion gas at the gas burner when the switch is switched into the on mode.

13. The household gas stove of claim 11, wherein the knob mechanism comprises a control element and a knob element which is held to the control element by the magnet such as to be removable and attachable.

14. The household gas stove of claim 13, wherein the knob mechanism comprises a stem which is arranged between the control element and the knob element, said knob element being attached to the stem.

15. The household gas stove of claim 14, wherein the stem and the knob element comprise a rotation axis, with the stem and the knob element rotating around the rotation axis relative to the control element, said switch being arranged at the control element, wherein the magnet is arranged at the stem to move the magnet as the stem is rotated around the rotation axis, and wherein the switch switches into the on mode when the movable magnet approaches the switch within the range of the magnetic field generated by the moveable magnet.

16. The household gas stove of claim 13, further comprising a top sheet which comprises a cooking area and includes an upper surface and a lower surface, with the magnet being arranged at the stem above the upper surface of the top sheet, and with the switch being arranged at the control element under the lower surface of the top sheet.

17. The household gas stove of claim 11, further comprising a device interacting with the switch such that the device is turned on when the switch is switched into the on mode and turned off when the switch is switched into the off mode.

18. The household gas stove of claim 17, wherein the device is an illumination device.

19. The household gas stove of claim 11, wherein the switch is a reed switch.

20. The household gas stove of claim 11, wherein the magnet is a permanent magnet or a solenoid.
